(19) United States
(12) Patent Application Publication
(10) Pub. No.: US 2026/0249697 A1
(43) Pub. Date: Aug. 27, 2026

(54) IN-VEHICLE SYSTEM AND INFORMATION PROCESSING DEVICE

(71) Applicant: TOYOTA JIDOSHA KABUSHIKI KAISHA, Toyota-shi (JP)

(72) Inventors: Hirotake SANO, Nagakute-shi (JP); Takashi OSAWA, Toyota-shi (JP); Ryota HAMABE, Nisshin-shi (JP); Miki TSUJINO, Ichinomiya-shi (JP); Shintaro MATSUTANI, Kariya-shi (JP); Hisashi FUJIWARA, Nisshin-shi (JP)

(73) Assignee: TOYOTA JIDOSHA KABUSHIKI KAISHA, Toyota-shi (JP)

(21) Appl. No.: 19/545,377

(22) Filed: Feb. 20, 2026

(30) Foreign Application Priority Data
Feb. 25, 2025 (JP) 2025-028104

(51) Int. Cl. B60K 35/65; B60K 35/10; B60K 35/22; B60K 35/29

(52) U.S. Cl. CPC B60K 35/658; B60K 35/10; B60K 35/22; B60K 35/29; B60K 2360/1434; B60K 2360/182; B60K 2360/782

(57) ABSTRACT

An in-vehicle system includes a display device and an information processing device. The display device includes a pair of display units provided in a portion in front of a driver seat. The pair of display units is respectively disposed in positions on lateral sides of a steering wheel so as to protrude farther rearward in the front-rear direction of the vehicle than an instrument unit placed in front of the steering wheel. The pair of display units each have a touch panel. The information processing device includes a control unit configured to execute outputting, to the display device, when a driver is to input information on the touch panel, a command that causes one of the pair of display units to display a screen on which the driver inputs the information in accordance with the dominant hand of the driver.

### CROSS-REFERENCE TO RELATED APPLICATION

This application claims priority to Japanese Patent Application No. 2025-028104 filed on Feb. 25, 2025. The disclosure of the above-identified application, including the specification, drawings, and claims, is incorporated by reference herein in its entirety.

### BACKGROUND

### 1. Technical Field

The present disclosure provides an in-vehicle system and an information processing device.

### 2. Description of Related Art

It has been known to have a display unit including a main display unit that displays vehicle information and an operation button display unit that is provided adjacent to the main display unit and that displays an operation button and to change the arrangement of the operation button display unit (for example, see Japanese Unexamined Patent Application Publication No. 2015-080994 (JP 2015-080994 A)).

### SUMMARY

The present disclosure improves the operability of a plurality of displays.

An in-vehicle system according to an aspect of the present disclosure includes a display device, a terminal of a driver of a vehicle, and an information processing device configured to output information via the display device.

The display device includes a pair of display units provided in a portion in front of a driver seat inside a vehicle cabin.

The pair of display units is respectively disposed in positions on lateral sides of a steering wheel so as to protrude farther rearward in the front-rear direction of the vehicle than an instrument unit placed in front of the steering wheel. The pair of display units each have a touch panel.

The information processing device includes a control unit and a storage unit.

The control unit is configured to further execute acquiring information about the driver from the terminal of the driver, identifying a dominant hand of the driver in accordance with information about the driver and information about the dominant hand of the driver that is stored in the storage unit, and outputting, to the display device, when the driver is to input information on the touch panel, a command that causes one of the pair of display units to display a screen on which the driver inputs the information in accordance with the dominant hand of the driver.

An in-vehicle system according to an aspect of the present disclosure includes a display device, and an information processing device configured to output information via the display device.

The display device includes a pair of display units provided in a portion in front of a driver seat inside a vehicle cabin.

The pair of display units is respectively disposed in positions on lateral sides of a steering wheel so as to protrude farther rearward in the front-rear direction of the vehicle than an instrument unit placed in front of the steering wheel. The pair of display units each have a touch panel.

The information processing device includes a control unit.

The control unit is configured to execute outputting, to the display device, when a driver of a vehicle is to input information on the touch panel, a command that causes one of the pair of display units to display a screen on which the driver inputs the information in accordance with the dominant hand of the driver.

In the in-vehicle system described above, the pair of display units may be disposed frontward of a grasped portion of the steering wheel in the front-rear direction of the vehicle.

In the in-vehicle system described above, the information processing device may include a storage unit configured to store information about the dominant hand of the driver. The control unit may be configured to acquire information about the driver from a terminal of the driver and identify the dominant hand of the driver from the information about the driver and the information about the dominant hand of the driver that is stored in the storage unit.

In the in-vehicle system described above, the information processing device may include a storage unit configured to store information about the dominant hand of the driver. The control unit may be configured to acquire the information about the driver from utterance of the driver and identify the dominant hand of the driver from the information about the driver and the information about the dominant hand of the driver that is stored in the storage unit.

In the in-vehicle system described above, the screen on which the driver inputs information may be a screen related to a map.

In the in-vehicle system described above, the screen on which the driver inputs information may be a screen on which a character is input.

An information processing device according to an aspect of the present disclosure includes a display device, and is configured to output information via the display device.

The display device includes a pair of display units provided in a portion in front of a driver seat inside a vehicle cabin.

The pair of display units is respectively disposed in positions on lateral sides of a steering wheel so as to protrude farther rearward in the front-rear direction of the vehicle than an instrument unit placed in front of the steering wheel. The pair of display units each have a touch panel.

The information processing device includes a control unit.

The control unit is configured to execute outputting, to the display device, when a driver of a vehicle is to input information on the touch panel, a command that causes one of the pair of display units to display a screen on which the driver inputs the information in accordance with the dominant hand of the driver.

In the information processing device described above, the pair of display units may be disposed frontward of a grasped portion of the steering wheel in the front-rear direction of the vehicle.

The information processing device described above may be configured to store information about the dominant hand of the driver. The control unit may be configured to acquire information about the driver from a terminal of the driver and identify the dominant hand of the driver from the information about the driver and the information about the dominant hand of the driver that is stored in the storage unit.

The information processing device described above may be configured to store information about the dominant hand of the driver. The control unit may be configured to acquire the information about the driver from utterance of the driver and identify the dominant hand of the driver from the information about the driver and the information about the dominant hand of the driver that is stored in the storage unit.

In the information processing device described above, the screen on which the driver inputs information may be a screen related to a map.

In the information processing device described above, the screen on which the driver inputs information may be a screen on which a character is input.

Other aspects of the present disclosure are a vehicle equipped with the above-described in-vehicle system, an information processing method that is executed by the above-described information processing device, a program that makes a computer execute that information processing method, and a computer-readable storage medium that non-transitorily stores that program.

With the present disclosure, it becomes possible to improve the operability of the displays.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view showing the inside of a vehicle cabin of a vehicle;

FIG. 2 is an enlarged view around a steering wheel;

FIG. 3 is a diagram schematically showing one example of the hardware configuration of the vehicle and a user terminal of the vehicle;

FIG. 4 is a diagram exemplifying a function configuration of an ECU;

FIG. 5 is a diagram showing one example of user information;

FIG. 6 is a view showing a screen on which a user registers a dominant hand;

FIG. 7 is a view showing a screen for inputting a destination displayed on an outer display;

FIG. 8 is a view showing a screen when a destination is input by a keyboard;

FIG. 9 is a view showing a screen when a destination is input by flick-input;

FIG. 10 is a flowchart of processing of displaying a navigation screen according to a first embodiment;

FIG. 11 is a flowchart showing processing of registering a dominant hand according to the first embodiment; and

FIG. 12 is a flowchart showing another processing of registering a dominant hand according to the first embodiment.

### DETAILED DESCRIPTION OF EMBODIMENTS

It can be conceived to include a touch panel in a vehicle and provide various services in accordance with touching of the touch panel by a user. At this time, cases in which characters are input or shapes are drawn can also be conceived. Here, when the touch panel is included on the opposite side of a dominant hand of the user, it becomes difficult for the user to input characters and the like.

A system that is one aspect of the present disclosure includes a display device, and an information processing device configured to output information via the display device. In the system, the display device includes a pair of display units provided in a portion in front of a driver seat inside a vehicle cabin. The pair of display units is respectively disposed in positions on lateral sides of a steering wheel so as to protrude farther rearward in the front-rear direction of the vehicle than an instrument unit placed in front of the steering wheel. The pair of display units each have a touch panel.

The display device includes the pair of display units respectively disposed in positions on the lateral sides of the steering wheel. The pair of display units has a configuration with which touch operation by the touch panel is possible. The pair of display units is preferably disposed in a position protruding rearward in the front-rear direction of the vehicle than an instrument unit (typically a meter panel on which a speedometer is disposed) placed in front of the steering wheel, in other words, a position closer to the driver in the front-rear direction of the vehicle. By providing the pair of display units in such a position, it becomes possible to dispose the touch panel in the vicinity of a part of the steering wheel that is grasped by the driver. In other words, it becomes possible to keep the amount of time that the driver releases their hands from the steering wheel at the time of operation to a minimum. The steering wheel does not necessarily need to have a circular shape as long as the steering wheel has a grasped portion and steering operation is performed by rotating the steering wheel.

The pair of display units presents information about the control of the vehicle or information about the convenience of occupants in the vehicle to the user, for example. The information about convenience for occupants of the vehicle may include information for providing entertainment to occupants in the vehicle, information about comfort of occupants, and/or the like. Examples of the information about the comfort and the convenience of occupants include information about an interface for operating audio, navigation, an air conditioner, a telephone, a clock, a voice assistant, and the like, and the activation situation of those equipment. The information about the control of the vehicle may include information about travel of the vehicle. Examples of the information about the control of the vehicle include information about an interface for operating headlights, wipers, side-view mirrors, an advanced driver assistance system (ADAS), a drive mode, the vehicle height, the position of the steering wheel, the position of the seats, or the like and the activation situation of those equipment.

Here, the information processing device includes a control unit configured to execute outputting, to the display device, when a driver of the vehicle is to input information on the touch panel, a command that causes one of the pair of display units to display a screen on which the driver inputs the information in accordance with the dominant hand of the driver. As above, the control unit displays a screen for inputting information on a screen disposed in a position in accordance with the dominant hand of the driver. As a result, the user can input information with the dominant hand, and hence it becomes easier for the user to input information.

In the following, embodiments of this disclosure will be described based on the drawings. The configurations of the following embodiments are presented as exemplifications, and the present disclosure is not restricted to the configurations of the embodiments. The following embodiments can be combined as far as possible.

### First Embodiment

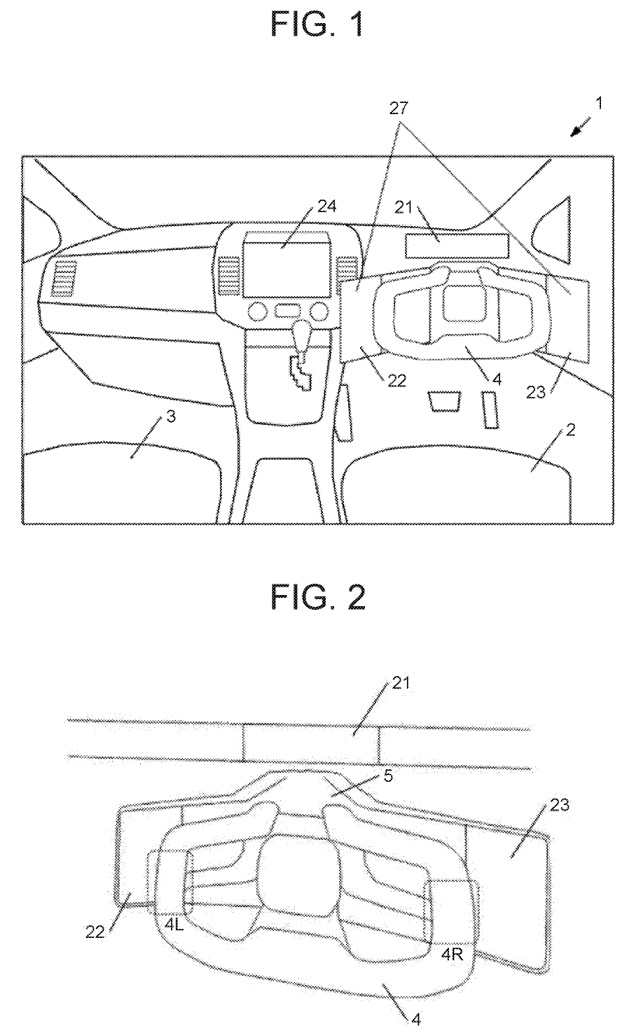

FIG. 1 is a view showing the inside of a vehicle cabin of a vehicle 1. As shown in the drawing, a driver seat 2 and a front passenger seat 3 are provided inside the vehicle cabin of the vehicle 1. The vehicle 1 of this embodiment is a right-hand drive vehicle, and the driver seat 2 is provided on the right side of the vehicle. On the front side of the driver seat 2, a steering wheel 4 is placed. The steering wheel 4 may have a circular shape or have a U-like shape as that shown in the drawing (a so-called irregular shaped steering wheel). The steering wheel 4 is connected to a steering device included in the vehicle 1 through a steering column. The steering column is covered by a column cover.

The front passenger seat 3 is provided on the left side of the driver seat 2, and a center display 24 is placed in an intermediate position between the driver seat 2 and the front passenger seat 3, in front of those seats in the front-rear direction of the vehicle. On the center display 24, assistive information, such as car navigation, and contents about entertainment, such as audio contents and television programs, for example, are displayed.

In front of the steering wheel 4 in the front-rear direction of the vehicle, a meter display 21 is provided. The meter display 21 is a full-screen display that is positioned on the front side of the driver seat 2 and provides various information to a driver of the vehicle 1. On the meter display 21, information required for travel of the vehicle, such as a speed of the vehicle (vehicle speed), an engine speed (when the vehicle 1 has an engine), a charge-discharge status (when the vehicle 1 has a driving battery), and a travel distance are displayed. The meter display 21 is one example of the "instrument unit" in the present disclosure.

A pair of display devices 27 is provided in a portion in front of the driver seat 2 inside the vehicle cabin. The pair of display devices 27 includes touch panel displays disposed in positions on lateral sides of the steering wheel 4. In this embodiment, a display 22 disposed close to the inner side of the vehicle is referred to as an inner display 22, and a display 23 disposed close to the outer side of the vehicle is referred to as an outer display 23. The inner display 22 and the outer display 23 are connected to an instrument panel of the vehicle 1.

With reference to FIG. 2, the detailed structure of the inner display 22 and the outer display 23 is described. FIG. 2 is an enlarged view around the steering wheel 4. The inner display 22 and the outer display 23 are vertically long displays and are connected to a support portion 5 that is a member that supports each of the displays. The support portion 5 has a shape that protrudes in the left-right direction of the steering wheel. The outer display 23 is connected to an end portion of the support portion 5 on the ride side thereof when viewed toward the front from the vehicle, and the inner display 22 is connected to an end portion of the support portion 5 on the left side thereof when viewed toward the front from the vehicle. Thus, a display displaying surface can be disposed near grasped portions of the steering wheel 4.

The description above is an example of a case in which the vehicle 1 is a right-hand drive vehicle, and the configuration is horizontally flipped when the vehicle 1 is a left-hand drive vehicle. In other words, the outer display 23 is connected to the end portion of the support portion 5 on the left side thereof when viewed toward the front from the vehicle, and the inner display 22 is connected to the end portion of the support portion 5 on the right side thereof when viewed toward the front from the vehicle.

The support portion 5 may also serve as a column cover that covers the steering column. The support portion 5 has a shape in which each part extends in the left-right direction (vehicle width direction) from a part in which the steering column pass therethrough and each of those parts extends rearward in the front-rear direction of the vehicle and is bent midway such that angles with respect to the left-right direction of the steering wheel 4 become smaller.

The inner display 22 and the outer display 23 are angled with respect to the left-right direction of the steering wheel, and each is disposed so as to be tilted to the steering wheel side. In other words, the inner display 22 is disposed so as to, on the inner side of the vehicle 1, protrude farther rearward in the front-rear direction of the vehicle 1, and the outer display 23 is disposed so as to, on the outer side of the vehicle 1, protrude farther rearward in the front-rear direction of the vehicle 1. As above, each of the inner display 22 and the outer display 23 is disposed to face the driver.

A region 4R indicated by the broken line in FIG. 2 is a part (grasped portion) at which the steering wheel 4 is grasped by the right hand, and a region 4L indicated by the broken line in FIG. 2 is a part (grasped portion) at which the steering wheel 4 is grasped by the left hand. The inner display 22 and the outer display 23 are disposed frontward of the grasped portions of the steering wheel 4 in the front-rear direction of the vehicle 1. Causing the support portion 5 to have the shape as described above allows the positions of the inner display 22 and the outer display 23 in the vehicle front-rear direction to be set closer to the grasped portions of the steering wheel 4. This can further reduce the amount of movement of the driver's hand when the driver performs a touch operation on the inner display 22 or the outer display 23 while driving.

The meter display 21, the inner display 22, and the outer display 23 are all displays having a touch panel. The touch panel only needs to have at least the inner display 22 and the outer display 23. As the touch panel, for example, a pressure-sensitive touch panel that detects a pressure with which a user presses the panel, or a capacitive touch panel that detects a change in capacitance when a user presses the panel can be adopted. The display is a liquid crystal display (LCD) or an electroluminescence (EL) panel, for example.

The inner display 22 displays information about convenience for occupants of the vehicle 1, for example. The information about convenience for occupants in the vehicle 1 includes information for providing amusement to the occupants in the vehicle 1. The information about convenience for occupants in the vehicle 1 may include information about comfort of occupants and the like. Examples of the information about comfort and convenience of occupants include information about switches, buttons, and the like for performing the operation of the audio, the operation of a navigation device, the operation of the air conditioner, the operation of the telephone, the operation of the clock, the operation of an AI partner (voice assistant), and the like and information about the activation situation of those devices.

The outer display 23 displays information about the control of the vehicle 1, for example. The information about the control of the vehicle 1 includes information about travel of the vehicle 1. Examples of the information about the control of the vehicle 1 include information about switches, buttons, and the like for performing the operation of power windows, the operation of the headlights, the operation of the wipers, the operation of the side-view mirrors, the operation of the ADAS, the operation of the drive mode, the operation of suspensions, the operation of the position of the steering wheel, the operation of the position of the seats, and the like and information about the activation situation of those devices. By displaying the information about the control of the vehicle 1 on the outer display 23, it becomes possible to reduce cases in which passengers other than the driver operate the information about the control of the vehicle 1.

The information to be displayed on the inner display 22 and the outer display 23 is not limited to those mentioned above. The inner display 22 may display information about the control of the vehicle 1, and the outer display 23 may display information about convenience for occupants of the vehicle 1. The information to be displayed on the inner display 22 and the outer display 23 can also be freely determined. As described below, information about an indicator displayed on the meter display 21 is displayed on the inner display 22 or the outer display 23.

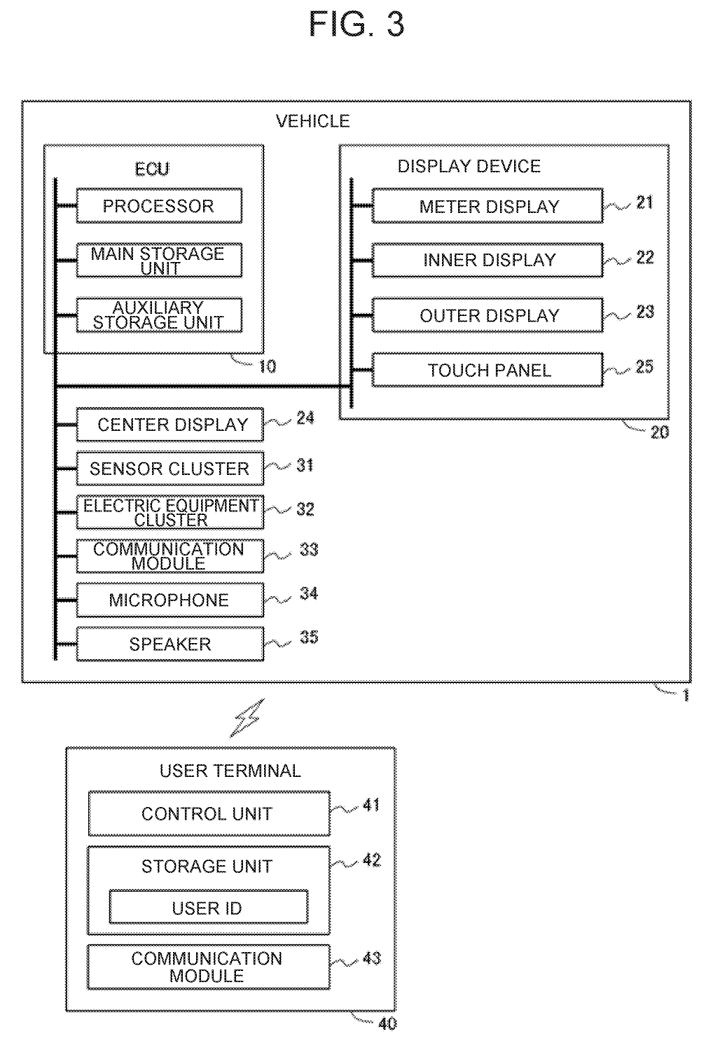

FIG. 3 is a diagram schematically showing one example of the hardware configuration of the vehicle 1 and a user terminal 40 of the vehicle 1. The user terminal 40 is a terminal carried by the driver of the vehicle 1. The vehicle 1 has an ECU 10, a display device 20, a center display 24, a sensor cluster 31, an electric equipment cluster 32, a communication module 33, a microphone 34, and a speaker 35. The ECU 10 can be configured as a computer having a processor (a CPU, a GPU, or the like), a main storage device (an RAM, an ROM, or the like), and an auxiliary storage device (an EPROM, a hard disc drive, a removable medium, or the like). An operating system (OS), various programs, various tables, and the like are stored in the auxiliary storage device, and each function (software module) that aligns with a predetermined purpose described later can be realized by executing the programs stored therein. However, some or all functions may be realized as a hardware module by a hardware circuit, such as an ASIC and an FPGA, for example. The display device 20, the center display 24, the sensor cluster 31, the electric equipment cluster 32, the communication module 33, the microphone 34, and the speaker 35 are connected to the ECU 10. The ECU 10 is one example of an information processing device.

The display device 20 has the meter display 21, the inner display 22, the outer display 23, and a touch panel 25. The touch panel 25 is a unit for detecting a touch operation performed on the meter display 21, the inner display 22, and the outer display 23. The meter display 21, the inner display 22, and the outer display 23 each have the touch panel 25 disposed thereon and can be operated by touching.

The sensor cluster 31 is an aggregate of a plurality of sensors for acquiring sensor data that is used in travel of the vehicle 1. The sensors may acquire physical amounts or may acquire image data and the like. The sensor cluster 31 includes sensors that detect states of the vehicle 1 and sensors that detect actions of the driver, for example. The sensor cluster 31 includes a speed sensor, an acceleration sensor, an accelerator operation amount sensor that detects the position of an accelerator pedal, a brake sensor that detects the position of a brake pedal, a steering wheel angle sensor that detects the angle of the steering wheel, an engine rotation speed sensor that detects the rotation speed of the engine, a water temperature sensor that detects the temperature of a coolant of the engine, an oil temperature sensor that detects the temperature of oil of the engine, an oil pressure sensor that detects the pressure of the oil of the engine, a sensor that detects the pressure of intake air of the engine, a yaw rate sensor, a turn signal switch sensor (a sensor that detects the state of a switch of a direction indicator), a shift position sensor, a sensor (GPS sensor) that detects location information, a sensor that detects the in-vehicle temperature, a sensor that detects the temperature outside the vehicle, and a radar that measures the distance from an object, for example.

The electric equipment cluster 32 is an aggregate of electric equipment used in the vehicle 1. The electric equipment cluster 32 can also include the power windows, the air conditioner, the suspensions, massage seats, the navigation device, an audio device, the telephone, the wipers, the headlights, the side mirrors, and the voice assistant.

The communication module 33 is means for performing near field communication between the vehicle 1 and the user terminal 40. The microphone 34 is means for acquiring utterance of the user and converts voice to an electrical signal. The speaker 35 is equipment that converts an electrical signal received from a control unit 100 to sound. The microphone 34 and the speaker 35 may be disposed in any of the meter display 21, the inner display 22, or the outer display 23.

The user terminal 40 is a terminal used by the driver of the vehicle 1 (user), and is a smartphone, a tablet terminal, a wearable terminal, or a personal computer (PC), for example. As another example, the user terminal 40 may be an electronic key of a smart key system. Application software that can change the setting of the vehicle 1, for example, is installed on the user terminal 40. The user terminal 40 includes a control unit 41, a storage unit 42, and a communication module 43. The control unit 41 of the user terminal 40 can be realized by a hardware processor, such as a CPU, for example. The control unit 41 may be configured to include a RAM, a read only memory (ROM), a cache memory, and the like. The storage unit 42 is means for storing information therein, and is configured by a storage medium, such as a RAM, a magnetic disk, or a flash memory. A program to be executed by the control unit 41, data to be used by the program, and the like are stored in the storage unit 42. The communication module 43 of the user terminal 40 has a configuration similar to that of the communication module 33 of the vehicle 1. The communication module 33 of the vehicle 1 and the communication module 43 of the user terminal 40 may include a wireless communication interface for near field communication, such as a Bluetooth (R), for example. The vehicle 1 and the user terminal 40 may be configured such that near field communication between the vehicle 1 and the user terminal 40 is possible. A user ID with which the user can be identified is stored in the storage unit 42 of the user terminal 40, and the user ID is transmitted to the vehicle 1 from the user terminal 40 when near field communication is performed between the vehicle 1 and the user terminal 40.

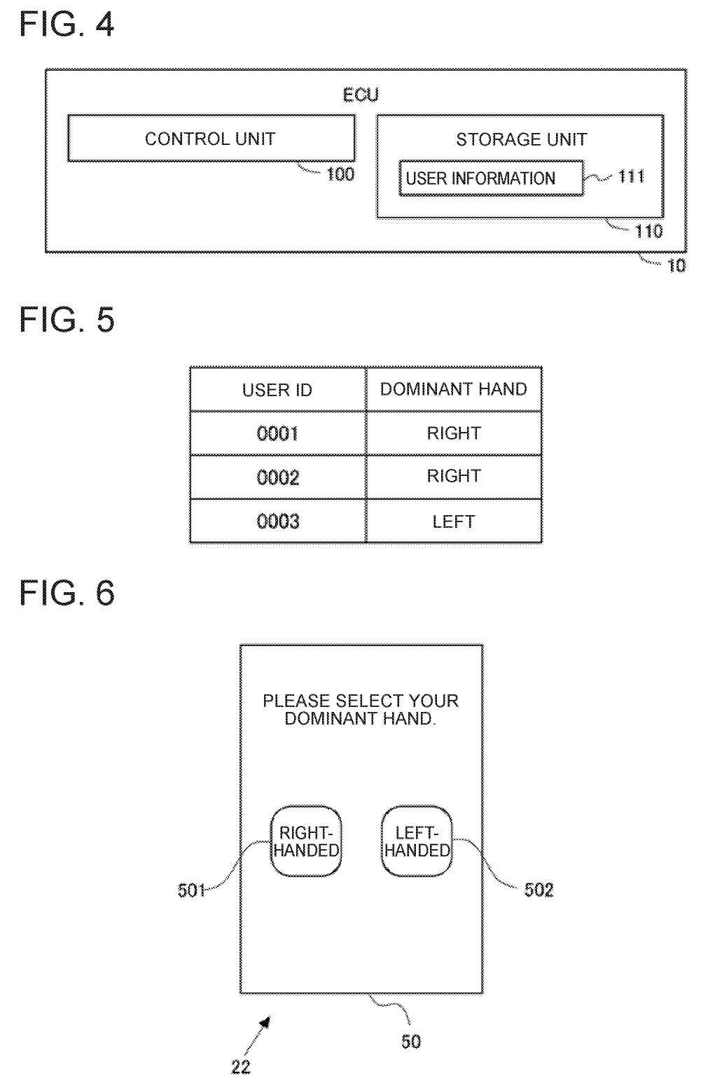

FIG. 4 is a diagram exemplifying a function configuration of the ECU 10. The ECU 10 includes the control unit 100 and a storage unit 110 as functional constituent elements. The control unit 100 is a functional constituent element provided by executing various programs stored in an auxiliary storage unit by the processor, for example. The storage unit 110 is means for storing information therein and configured to include a main storage unit and an auxiliary storage unit. In the storage unit 110, user information 111 is stored.

FIG. 5 is a diagram showing one example of the user information 111. The user information 111 is information indicating a dominant hand of the user and is information about the dominant hand linked to the user ID. The user ID may be linked to a mobile terminal (for example, a smartphone) of the user or an electronic key corresponding to a smart key and may be linked to the voice of the user, for example. As another example, the control unit 100 may identify the user ID by performing image analysis of a face of the user imaged by a camera, for example. The information about the dominant hand of the user is registered by the user in advance via the touch panel 25. In the information about the dominant hand, "right" is stored in the user information 111 when the dominant hand of the user is the right hand, and "left" is stored in the user information 111 when the dominant hand of the user is the left hand.

FIG. 6 is a view showing a screen 50 on which the user registers the dominant hand. The registration screen 50 is displayed when the user touches a graphical user interface (GUI) part for transitioning to a screen for registering the dominant hand displayed on the inner display 22 or the outer display 23. At this time, the control unit 100 transmits a command for displaying a GUI part 501 for registering the user as right-handed and a GUI part 502 for registering the user as left-handed on the registration screen 50 to the display device 20. The control unit 100 determines which GUI part is touched in accordance with a touch signal received from the touch panel 25, links the touched GUI part to the user ID, and stores the touched GUI part in the storage unit 110 as the user information 111.

Here, the control unit 100 provides a conversational service by a virtual agent (AI partner) that can perform conversation by a natural language. The control unit 100 displays a character of the virtual agent on the inner display 22 or the outer display 23, and the user can set a destination by having a conversation with the character, for example. When the control unit 100 acquires the destination from the user by this conversation, the control unit 100 searches for a route from a current location of the vehicle 1 to a destination and executes route guidance. A screen related to the navigation as above corresponds to information about the convenience of the occupants, and hence is displayed on the inner display 22.

The control unit 100 can display a map on the pair of display devices 27 and set a place on the map touched or circled by the user as a destination in the conversational service. Here, the navigation is a service related to the convenience of the user, and hence is normally displayed on the inner display 22. In other words, the map is displayed on the left side of the user. At this time, when the user is right-handed, the user handles the map with a hand opposite to the dominant hand. Therefore, it becomes difficult to perform operation that requires precision.

Thus, in this embodiment, the control unit 100 displays a screen that requires input by the user on a display disposed on the side of the dominant hand of the user out of the inner display 22 and the outer display 23. Information about the screen that requires input by the user is stored in the storage unit 110.

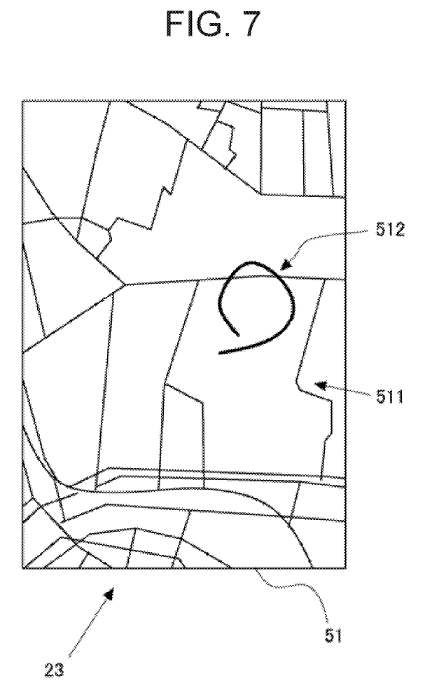

FIG. 7 is a view showing a screen 51 for inputting a destination displayed on the outer display 23. Description is made below by considering the dominant hand of the user to be the right hand. A map 511 is displayed, and the user draws a circle 512 on the map 511. As a result, the control unit 100 searches for a landmark existing inside the circle 512 and sets the landmark as a destination. The control unit 100 identifies a location on the map touched by the user from a touch signal received from the touch panel 25 and map information stored in the storage unit 110. When a plurality of landmarks exists, names or descriptions corresponding to the landmarks may be displayed on the map 511, and a landmark touched by the user out of those landmarks may be set as the destination. As another example, the control unit 100 may set a place around the center of the circle 512 as the destination. Similarly, when the user touches the map, a location touched by the user may be set as a destination, or a landmark closest to the location touched by the user may be searched for and be set as a destination.

When there is predetermined input to the microphone 34, the control unit 100 may display the map 511 for inputting a destination on the outer display 23. The predetermined input is a request about setting a destination, such as "I am deciding where to go" or "There is a place I want to go", for example. Utterance corresponding to the predetermined input is stored in the storage unit 110.

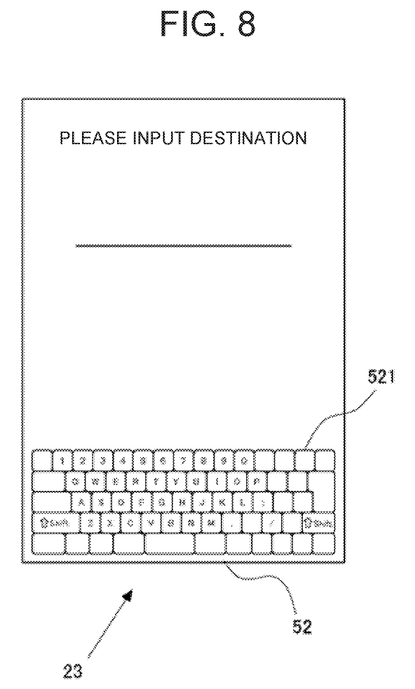

When the user operates a GUI part, such as a keyboard, the GUI part is displayed on the side of the dominant hand of the user in this case as well. FIG. 8 is a view showing a screen 52 when a destination is input by a keyboard. The control unit 100 transmits a command to the display device 20 such that a keyboard is displayed on the display on the dominant hand side (the outer display 23 in FIG. 8) as a GUI part 521. The control unit 100 identifies a character input by the user in accordance with a touch signal.

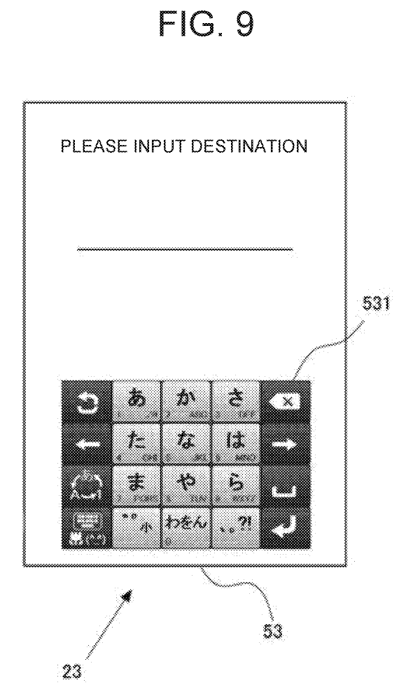

FIG. 9 is a view showing a screen 53 when a destination is input by flick-input. The control unit 100 transmits a command to the display device 20 such that a GUI part 531 with which flick-input is possible is displayed on the display on the dominant hand side (the outer display 23 in FIG. 9). The control unit 100 identifies a character input by the user in accordance with a touch signal. Other than the above, when the user performs handwriting-input, for example, a screen for performing handwriting-input is displayed on the display on the side of the dominant hand of the user. For example, when a destination cannot be set with voice-input because the way of reading a Chinese character is unknown, the destination can be set by performing handwriting-input. In this case, an algorithm for identifying characters in accordance with a touch signal is stored in the storage unit 110, and the control unit 100 can set a destination in accordance with the identified character.

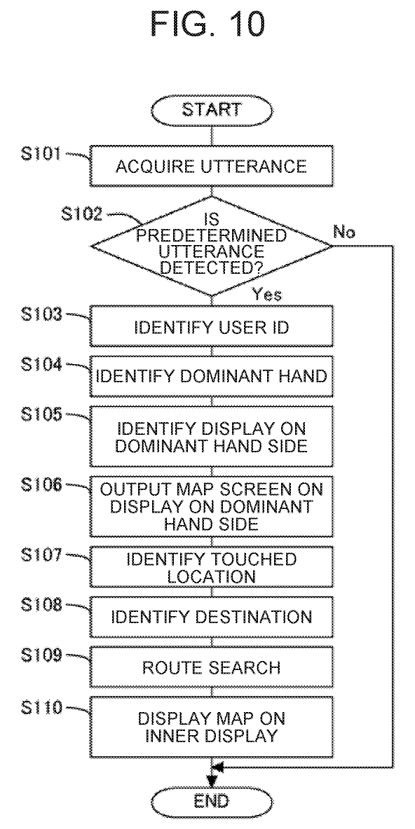

FIG. 10 is a flowchart of processing of displaying a navigation screen according to the first embodiment. The processing shown in FIG. 10 is repeatedly executed every predetermined number of hours in the ECU 10.

In Step S101, the control unit 100 acquires utterance. The control unit 100 acquires utterance of the user input to the microphone 34. When the processing in Step S101 is completed, the processing proceeds to Step S102.

In Step S102, the control unit 100 determines whether predetermined utterance is detected. The predetermined utterance is utterance for the user to input a destination with use of the touch panel 25. The control unit 100 determines that predetermined utterance is detected when the utterance of the user includes a predetermined keyword stored in the storage unit 110. The keyword may be "I want to input a destination" or "I want to choose a destination from the screen", for example. At this time, the control unit 100 may perform determination based on a well-known language recognition technology. The control unit 100 may determine whether there is input including a predetermined keyword when the user has a conversation with a virtual agent (AI partner) that can have a conversation in natural language. In Step S102, the processing proceeds to Step S103 when the control unit 100 makes an affirmative determination, and the routine ends when the control unit 100 makes a negative determination.

In Step S103, the control unit 100 identifies a user ID. For example, the control unit 100 may perform near field communication with the user terminal 40 and acquire information about the user ID from the user terminal 40. As another example, the control unit 100 may acquire information about the user ID linked to the electronic key. As yet another example, the control unit 100 may acquire information about the user ID by voice recognition in accordance with the utterance of the user. At this time, the control unit 100 may identify the user ID by obtaining an acoustic feature from the utterance of the user and comparing the acoustic feature with acoustic features of user IDs stored in the storage unit 110, for example. At this time, the control unit 100 may use a mel-frequency cepstrum coefficient (MFCC), for example. The user ID may be identified by biometric authentication and face authentication. For example, fingerprint authentication may be executable when the user touches the inner display 22 or the outer display 23. When the processing in Step S103 is completed, the processing proceeds to Step S104.

In Step S104, the control unit 100 identifies a dominant hand of the user. The control unit 100 identifies the dominant hand of the user from the user information 111 in accordance with the user ID identified in Step S103. At this time, the control unit 100 identifies that the dominant hand of the user is the right hand, for example. When the processing in Step S104 is completed, the processing proceeds to Step S105.

In Step S105, the control unit 100 identifies a display in accordance with the dominant hand identified in Step S104. At this time, the control unit 100 identifies that the display in accordance with the dominant hand is the inner display 22 when the user is left-handed, and identifies that the display in accordance with the dominant hand is the outer display 23 when the user is right-handed. In the case of a left-hand drive vehicle, the control unit 100 identifies that the display in accordance with the dominant hand is the outer display 23 when the user is left-handed, and identifies that the display in accordance with the dominant hand is the inner display 22 when the user is right-handed. When the processing in Step S105 is completed, the processing proceeds to Step S106.

In Step S106, the control unit 100 transmits a command to the display device 20 such that a screen 51 for inputting a destination as shown in FIG. 7 is displayed on the display identified in Step S105. The screen 51 for inputting a destination may be a screen that displays a map of a predetermined range including a current location detected by a GPS sensor included in the sensor cluster 31, for example. As another example, a screen on which the user can input a map to the touch panel 25 may be displayed. In this case, the control unit 100 may be configured to be able to search for a map in accordance with the input of the user. When the processing in Step S106 is completed, the processing proceeds to Step S107.

In Step S107, the control unit 100 identifies a location touched by the user in accordance with a touch signal from the touch panel 25. The control unit 100 identifies the location on the map that the user has touched in accordance with a touch signal. The map displayed on the outer display 23 is stored in the storage unit 110. When the user indicates a range on the map 511 by the circle 512, the control unit 100 identifies the range. When the processing in Step S107 is completed, the processing proceeds to Step S108.

In Step S108, the control unit 100 identifies a destination. The control unit 100 may set the location on the map 511 touched by the user as the destination. As another example, the control unit 100 may identify a landmark closest to the touched location as a destination. Information about landmarks is stored in the storage unit 110. When the user indicates a range by the circle 512, a landmark included in the range is identified. At this time, when a plurality of landmarks is included, the control unit 100 may list landmarks that have been searched for on the outer display 23 and may let the user select a landmark. Then, the landmark selected by the user may be identified in accordance with a touch signal from the touch panel 25. When the processing in Step S108 is completed, the processing proceeds to Step S109.

In Step S109, the control unit 100 executes route search to the landmark identified in Step S108. The control unit 100 executes the route search in accordance with a current location identified in accordance with a signal from the GPS sensor and the identified destination. At this time, the control unit 100 searches for a route in accordance with a logic stored in the storage unit 110. Map information used at this time is stored in the storage unit 110. When the processing in Step S109 is completed, the processing proceeds to Step S110.

In Step S110, the control unit 100 outputs a command for displaying the route that has been searched for, the own vehicle location, and the map on the inner display 22, to the display device 20. The navigation screen is displayed on the inner display 22 as usual.

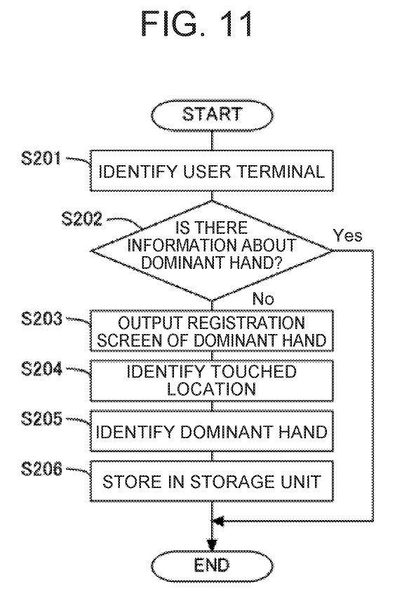

FIG. 11 is a flowchart showing processing of registering the dominant hand according to the first embodiment. The processing shown in FIG. 11 is executed in the ECU 10 with a trigger being the user touching a GUI part for transitioning to a screen for registering a dominant hand displayed on the inner display 22 or the outer display 23.

In Step S201, the control unit 100 identifies the user terminal 40. The control unit 100 performs near field communication with the user terminal 40 and identifies the user terminal 40. At this time, the user ID stored in the storage unit 42 of the user terminal 40 is transmitted to the vehicle 1 from the user terminal 40, and hence the control unit 100 acquires the user ID from the user terminal 40. When the processing in Step S201 is completed, the processing proceeds to Step S202.

In Step S202, the control unit 100 determines whether information about a dominant hand corresponding to the user ID exists in the user information 111. When the acquired user ID is not stored or information about a dominant hand corresponding to the acquired user ID does not exist in the user information 111, the control unit 100 makes a negative determination. In Step S202, the processing proceeds to Step S203 when the control unit 100 makes a negative determination, and the routine ends when the control unit 100 makes an affirmative determination.

In Step S203, the control unit 100 outputs a command to the display device 20 such that the registration screen 50 of a dominant hand as shown in FIG. 6 is displayed. When the processing in Step S203 is completed, the processing proceeds to Step S204.

In Step S204, the control unit 100 identifies a location touched by the user on the registration screen 50 of a dominant hand in accordance with a touch signal from the touch panel 25. When the processing in Step S204 is completed, the processing proceeds to Step S205.

In Step S205, the control unit 100 identifies a dominant hand of the user in accordance with the location touched by the user and the location of a GUI part disposed on the registration screen 50 of a dominant hand. The control unit 100 identifies a dominant hand of the user by identifying which GUI part out of the GUI part 501 for registering the user as right-handed and the GUI part 502 for registering the user as left-handed is touched. When the processing in Step S205 is completed, the processing proceeds to Step S206.

In Step S206, the control unit 100 stores the dominant hand of the user in the storage unit 110 as the user information 111. At this time, the control unit 100 stores the information about the dominant hand in the storage unit 110 in association with the user ID identified in Step S201.

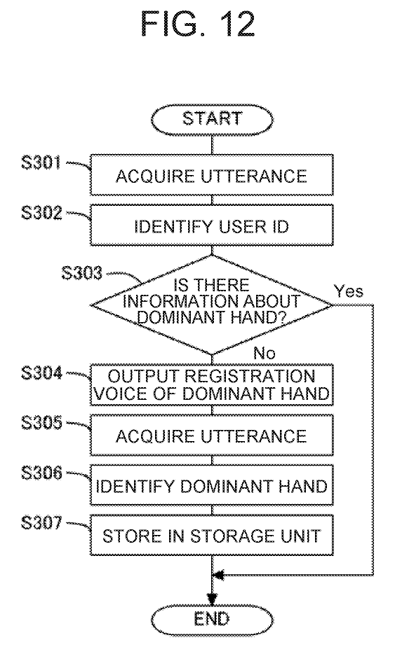

FIG. 12 is a flowchart showing another processing of registering a dominant hand according to the first embodiment. The processing shown in FIG. 12 is executed in the ECU 10 with a trigger being the detection of utterance of the user.

In Step S301, the control unit 100 acquires utterance of the user from the microphone 34. When the processing in Step S301 is completed, the processing proceeds to Step S302.

In Step S302, the control unit 100 identifies a user ID. The control unit 100 identifies the user ID by obtaining an acoustic feature from the utterance of the user and comparing the acoustic feature with acoustic features of user IDs stored in the storage unit 110, for example. In Step S302, the control unit 100 may acquire a user ID from the user terminal 40 or the electronic key as with the processing in Step S201 described above. The control unit 100 may newly issue a user ID when a user ID corresponding to the utterance does not exist. When the processing in Step S302 is completed, the processing proceeds to Step S303.

In Step S303, the control unit 100 determines whether information about a dominant hand corresponding to the user ID exists in the user information 111. When the acquired user ID is not stored or information about a dominant hand corresponding to the acquired user ID does not exist in the user information 111, the control unit 100 makes a negative determination. In Step S303, the processing proceeds to Step S304 when the control unit 100 makes a negative determination, and the routine ends when the control unit 100 makes an affirmative determination.

In Step S304, the control unit 100 outputs a command for playing a voice asking the user the dominant hand from the speaker 35. At this time, the control unit 100 outputs a command so as to play a voice saying, "Which hand is your dominant hand?", "Are you right-handed or left-handed?", or the like from the speaker 35, for example. When the processing in Step S304 is completed, the processing proceeds to Step S305.

In Step S305, the control unit 100 acquires utterance of the user by the microphone 34. When the processing in Step S305 is completed, the processing proceeds to Step S306.

In Step S306, the control unit 100 identifies a dominant hand with use of a well-known language recognition technology from the utterance of the user acquired in Step S305. When the processing in Step S306 is completed, the processing proceeds to Step S307.

In Step S307, the control unit 100 stores the dominant hand of the user in the storage unit 110 as the user information 111. At this time, the control unit 100 stores the information about the dominant hand in the storage unit 110 in association with the user ID identified or issued in Step S302.

As described above, with this embodiment, when the user needs to perform input to a screen, the screen is output such that input on a display disposed on the dominant hand side is possible. As a result, it becomes easier for the user to perform input to the screen.

### Other Embodiments

The above-described embodiments are merely examples, and this disclosure can be implemented with changes made thereto, as appropriate, without departing from the gist of the disclosure. The processing and means described in this disclosure can be implemented in freely selected combinations as long as no technical inconsistency arises. Processing that has been described as being performed by one device may be shared and executed by a plurality of devices. Alternatively, processing described as being performed by different devices may be executed by one device. What hardware configuration is used to realize each function in a computer system can be flexibly changed.

In the embodiment described above, a case of inputting characters when a destination of a map is to be set has been described, but the present disclosure is not limited to a map, and the control unit 100 may output a command that displays a screen for inputting characters or shapes on a display on the dominant hand side when the user inputs characters or shapes.

The present disclosure can also be realized by supplying a computer program equipped with the functions described in the above-described embodiment to a computer and making one or more processors belonging to the computer retrieve and execute the program. Such a computer program may be provided to a computer by a non-transitory computer-readable storage medium that can be connected to a system bus of the computer, or may be provided to a computer through a network. Examples of non-transitory computer-readable storage media include arbitrary types of discs, such as magnetic discs (a floppy (R) disk, a hard disc drive (HDD), and the like) and optical discs (a CD-ROM, a DVD disc, a Blu-ray disc, and the like), a read-only memory (ROM), a random-access memory (RAM), an EPROM, an EEPROM, a magnetic card, a flash memory, an optical card, and freely-selected types of media suitable for storing electronic instructions.

What is claimed is:

1. An in-vehicle system, comprising:
a display device;
a terminal of a driver of a vehicle; and
an information processing device configured to output information via the display device, wherein:
the display device includes a pair of display units provided in a portion in front of a driver seat inside a vehicle cabin;
the pair of display units is respectively disposed in positions on lateral sides of a steering wheel so as to protrude farther rearward in a front-rear direction of the vehicle than an instrument unit placed in front of the steering wheel, the pair of display units each having a touch panel;
the information processing device includes a control unit and a storage unit; and
the control unit is configured to execute:
acquiring information about the driver from the terminal of the driver;
identifying a dominant hand of the driver in accordance with information about the driver and information about the dominant hand of the driver that is stored in the storage unit; and
outputting, to the display device, when the driver is to input information on the touch panel, a command that causes one of the pair of display units to display a screen on which the driver inputs the information in accordance with the dominant hand of the driver.

2. An in-vehicle system, comprising:
a display device;
an information processing device configured to output information via the display device, wherein:
the display device includes a pair of display units provided in a portion in front of a driver seat inside a vehicle cabin;
the pair of display units is respectively disposed in positions on lateral sides of a steering wheel so as to protrude farther rearward in a front-rear direction of the vehicle than an instrument unit placed in front of the steering wheel, the pair of display units each having a touch panel;
the information processing device includes a control unit; and
the control unit is configured to execute outputting, to the display device, when a driver of a vehicle is to input information on the touch panel, a command that causes one of the pair of display units to display a screen on which the driver inputs the information in accordance with the dominant hand of the driver.

3. The in-vehicle system according to claim 2, wherein the pair of display units is disposed frontward of a grasped portion of the steering wheel in the front-rear direction of the vehicle.

4. The in-vehicle system according to claim 2, wherein:
the information processing device includes a storage unit configured to store information about the dominant hand of the driver; and
the control unit is configured to acquire information about the driver from a terminal of the driver and identify the dominant hand of the driver from the information about the driver and the information about the dominant hand of the driver that is stored in the storage unit.

5. The in-vehicle system according to claim 2, wherein:
the information processing device includes a storage unit configured to store information about the dominant hand of the driver; and
the control unit is configured to acquire the information about the driver from utterance of the driver and identify the dominant hand of the driver from the information about the driver and the information about the dominant hand of the driver that is stored in the storage unit.

6. The in-vehicle system according to claim 2, wherein the screen on which the driver inputs information is a screen related to a map.

7. The in-vehicle system according to claim 2, wherein the screen on which the driver inputs information is a screen on which a character is input.

8. An information processing device, comprising a display device, the information processing device being configured to output information via the display device, wherein:
the display device includes a pair of display units provided in a portion in front of a driver seat inside a vehicle cabin;
the pair of display units is respectively disposed in positions on lateral sides of a steering wheel so as to protrude farther rearward in a front-rear direction of the vehicle than an instrument unit placed in front of the steering wheel, the pair of display units each having a touch panel;
the information processing device includes a control unit; and
the control unit is configured to execute outputting, to the display device, when a driver of a vehicle is to input information on the touch panel, a command that causes one of the pair of display units to display a screen on which the driver inputs the information in accordance with the dominant hand of the driver.

9. The information processing device according to claim 8, wherein the pair of display units is disposed frontward of a grasped portion of the steering wheel in the front-rear direction of the vehicle.

10. The information processing device according to claim 8, wherein:
the information processing device includes a storage unit configured to store information about the dominant hand of the driver; and
the control unit is configured to acquire information about the driver from a terminal of the driver and identify the dominant hand of the driver from the information about the driver and the information about the dominant hand of the driver that is stored in the storage unit.

11. The information processing device according to claim 8,
the information processing device includes a storage unit configured to store information about the dominant hand of the driver; and
the control unit is configured to acquire the information about the driver from utterance of the driver and identify the dominant hand of the driver from the information about the driver and the information about the dominant hand of the driver that is stored in the storage unit.

12. The information processing device according to claim 8, wherein the screen on which the driver inputs information is a screen related to a map.

13. The information processing device according to claim 8, wherein the screen on which the driver inputs information is a screen on which a character is input.
